(19) United States
(12) Patent Application Publication
(10) Pub. No.: US 2003/0233267 A1
(43) Pub. Date: Dec. 18, 2003

(54) Project management

(76) Inventor: Martin Hertel-Szabadi, Heidelberg (DE)

Correspondence Address: MARK D. KIRKLAND, Fish & Richardson P.C., 60 South Sixth Street, 3300 Dain Rauscher Plaza, Minneapolis, MN, 55402, US

(21) Appl. No.: 10/161,067

(22) Filed: May 30, 2002

(51) Int. Cl. G06F 17/60

(52) U.S. Cl. 705/9

(57) ABSTRACT

A project workforce management system defines project positions and may correlate the project positions to project tasks. By defining a project in terms of project positions, a manager can better control determine the level of personnel needed to work on a project and complete projects more efficiently. Also, the correlation between the project positions and project tasks allows a manager to determine the level of effort that is needed by each project position to complete the project.

### TECHNICAL FIELD

This invention relates to project management systems and methods, and more particularly to a software-based system and method for project management.

### BACKGROUND

Professional Service Organizations operate through projects, i.e. through discrete engagements for external or internal clients or customers, delivered according to an agreed-upon scope, schedule, fee, and set of deliverables. In the services supply chain of a Professional Service Organization people and time are the most important resources where delivering on a project is paramount.

Service Providers normally sell projects and manpower as their products. Thus they need the integration with a project management solution throughout the customer engagement lifecycle. In the engage phase, a project is created and structured according to the specific needs, high level project planning is performed to estimate the personnel and other resources required and to structure the workload. Thus the project structure with phases (work breakdown structure elements) and the necessary activities (tasks) have to be defined. Costs and potential revenues have to be calculated, timelines to be scheduled and probably personnel and other resources soft-booked, in order to be able to do reasonable and reliable quotations that can be fulfilled in case they are accepted by the customer. In the transact phase, when the project is won, project planning is continually refined, budgeting, cost-and revenue planning is performed more detailed, and resources are hard-booked. In the fulfill phase, consultants work on the project tasks, and record their activities and times, travel-and other expenses on work breakdown structure elements. These expenses or costs occurred can be billed resource related, according to project milestones, periodically, or with a fixed price. The project manager monitors costs or budgets vs. revenues, timelines vs. deadlines, project progress, and takes appropriate action.

Good project management is an important factor to the success of a project. A project may be thought of as a collection of activities and tasks designed to achieve a specific goal of the organization, with specific performance or quality requirements while meeting any subject time and cost constraints. Project management refers to managing the activities that lead to the successful completion of a project. Project management focuses on finite deadlines and objectives. A number of tools may be used to assist with project management and assessment.

Project management may be used when planning of personnel resources and check capacities is desired. The project may be linked to the objects in a professional services life cycle and may accompany the objects from the opportunity over quotation, contract, time and expense (T&E) recording, billing, period-end-activities until the final reporting. Naturally the project gets even more detailed when moving through this cycle.

A project may arise as an opportunity or a request for quotation (inquiry) sent by a potential customer. When the opportunity or request arrives, a decision has to take place by the manager whether the opportunity should be pursued or a quotation be submitted. Even at this early stage, it is important to check whether the company has the necessary capacity and resources with the required skills and qualifications available at the requested time.

Typically for any given project, several project tasks are defined. Project tasks describe the activities and phases that have to be performed in the project such as writing of blueprints, customizing, testing etc. and can be arranged hierarchically.

Often however, it is desired to view a project in terms of the project roles that are needed. Project roles define a position a person may occupy in a project, such as project manager, consultant, tester, etc. This allows a project manager to obtain a better view of the manpower that may be required to complete a project.

What is needed is a system that allows a project to be defined using project positions instead of project tasks. Project positions describe project roles like project manager, consultant, tester, etc. By defining a project using project positions, a project manager may plan a project only using the project roles.

### SUMMARY

A project workforce management system defines project positions and may correlate the project positions to project tasks. By defining a project in terms of project positions, a manager can better control determine the level of personnel needed to work on a project and complete projects more efficiently. Also, the correlation between the project positions and project tasks allows a manager to determine the level of effort that is needed by each project position to complete the project.

### DESCRIPTION OF DRAWINGS

These and other features and advantages of the invention will become more apparent upon reading the following detailed description and upon reference to the accompanying drawings.

FIG. 1 illustrates the overall structure of a project management system.

FIG. 2 illustrates a process for generating a project in a project management system.

FIG. 3 illustrates a process for determining project positions in a project management system.

### DETAILED DESCRIPTION

Projects very often are created by the consultants manager or by a dedicated project manager due to a specific need. It might be necessary to estimate project costs and timelines to be able to bid and send a quotation to a potential customer or to be able to decide whether an opportunity should be pursued or to be able to fulfill the commitments of a contract with a customer. If a model is created using only project tasks, the project manager may not be able to easily determine whether he has sufficient manpower to perform the project. However, modeling a project using project positions provides the project manager with a simple view of the personnel requirements to complete a project.

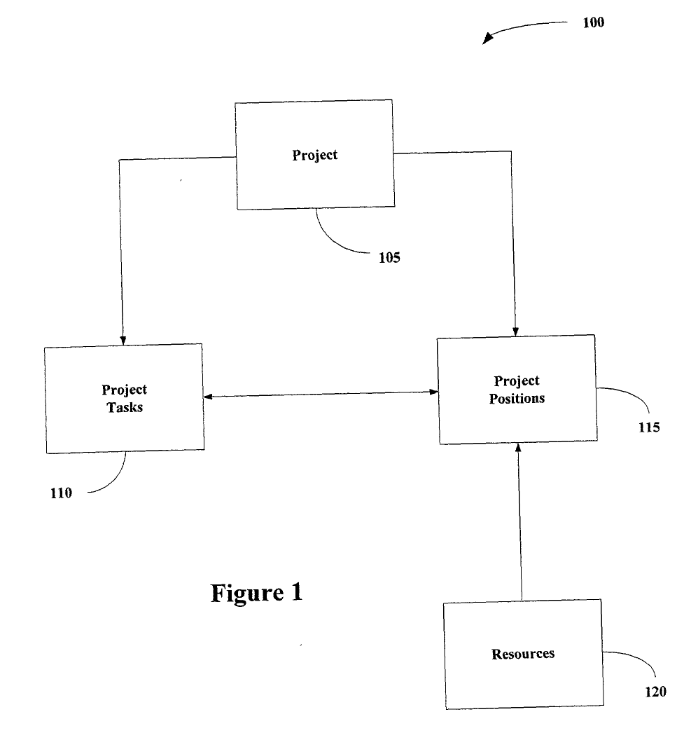

FIG. 1 illustrates the overall structure of project management system 100 showing the relationship between a project 105, project tasks 110, project positions 115, and resources 120. The project 100 is a strategy to achieve a defined goal of an organization. The project 100 may be divided into a series of project tasks 110 and/or a series of project positions 115.

The project 105 may be structured by creation of a hierarchical model, consisting of project positions 115, with an unlimited number of levels to be able to detail the project 105 as far as necessary. The project positions 115 may be the basis for planning, analysis, description, control, and monitoring costs, basic dates, and budgets. The project positions 115 are used to cover and continually update plan and actual data. Due to the hierarchical structure summarizations from bottom to top and also distributions from top to bottom are possible.

Templates should be available to simplify the creation of such a project 105 and copying rules are important to create one project 105 out of another.

The project tasks 110 define activities and phases to be performed in the project 105. For example, for a construction project examples of project tasks 110 may include preparing blue prints, obtaining the proper permits, preparing the foundation, ordering the lumber, hiring sub-contractors, etc. The project tasks 110 describe operational activities or phases in the project 105 that should be performed like analysis, business blueprint, implementation, and documentation. The project tasks 110 describe qualification requirements and time demand: To be able, e.g., to write a business blueprint document it is necessary to have attended a specific training session and to be available in the first weeks of September. Project tasks 110 have a hierarchical structure, i.e. tasks can be grouped or split up. Sometimes the refinement and split of tasks into several sub-tasks occurs at a later time in the life cycle of the project 110.

The project positions 115 define project roles by job title. For the same construction example, project positions 115 may include architect, foreman, electrician, mason, supervisor, etc. The project positions 115 may include qualifications and requirements for each project position 115. Thus, a project position 115 may require availability (such as during the month of July) and certain certifications (such as certification for high voltage installations, professional licenses). The project positions 115 represent roles in the project 105 and describe what roles with what requirements exist in the project 105. The project positions 115 may be described by fields like position type, category, time demand, description, qualification requirements, etc. One example for such a position is the project manager. The qualification requirements for this position might be: account expert, at least two similar projects done, available from September until November for at least 80% of the time. Project positions 115 are non-hierarchical and can be represented by a linear list assigned to a project header. It might be necessary to change the project positions 115 continually during the life cycle of the project 105.

The resources 120 describe a particular person or group that may fill a project position. For a company project 105, the resources 120 may be all the employees of the company. The resources 120 are listed by name and may also include job title, availability, qualifications or other information. The resources 120 may also include any other personnel the company may use, including contractors and temporary workers.

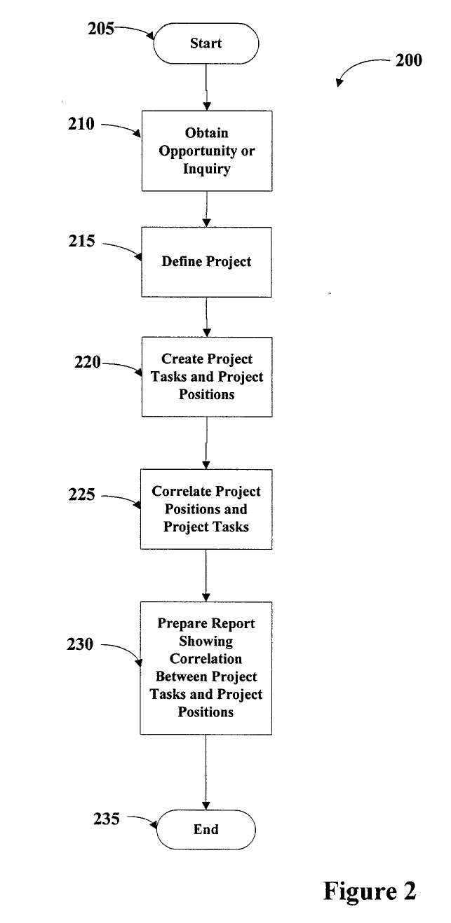

FIG. 2 illustrates a process 200 for generating a project in a project management system. The process 200 begins at a START block 205. Proceeding to block 210, an opportunity of inquiry is obtained. An opportunity or inquiry asks for a simple or complex engagement, where one or more persons are required to perform dedicated tasks. This engagement is requested to be performed in a defined time frame.

Proceeding to block 215, the process 200 defines a project 105 based on the opportunity or inquiry. The project 105 may be defined to check whether it is possible and reasonable to make an offer (quotation).

Proceeding to block 220, the requirements and tasks of the project 105 may be structured as project tasks 110 and the positions (roles) have to be estimated and structured as project positions 115. As described above, the project tasks 110 define activities and phases to be performed in the project 105 and the project positions 115 define project roles by job title.

Proceeding to block 225, the project positions 115 and the project tasks 110 are correlated. Within the project 105 a correlation between project positions 115 and project tasks 110 is performed by the project manager or a resource manager. The correlation describes what project position (role) 115 is responsible to work on a project task 110. It is possible to correlate one project position 115 to several project tasks 110. During the correlation of a project position 115 to a project task 110, the project position 115 acts as a supplier or (nominal) resource that fulfills the time demand and qualification requirements of the project task 110. Thus a matching of time and qualification data between project positions 115 and project tasks 110 should be possible.

Proceeding to block 230, an optional report may be prepared. An integrated reporting functionality is available within the project 105. The reporting functionality may show all project tasks 110 for a project position 115 or all project positions 115 that are assigned to a project task 110.

The process 200 can be accomplished by a consulting manager or by a (potential) project manager using software on a computer. The project 105 does not have to be highly complex or lengthy. For example, in a case of a so-called spot-consulting scenario (example: a consultant is needed for two days to define a report) the consulting project consists only of one position and the single task is represented by the consulting project itself.

The planning of structures, costs, revenues, resources, timeliness etc. can and will normally be refined and detailed during the life cycle of the project 105. For example, in the opportunity phase it might be enough to plan a project 105 in a very rough way to estimate costs and timelines. If a quotation is sent to the (potential) customer and is accepted and a contract is signed, the same project 105 can be used as an operative project. In this case, more details, more exact times, costs, revenues, personnel resources etc. may be added. During the execution of the project 105, these values could be updated permanently.

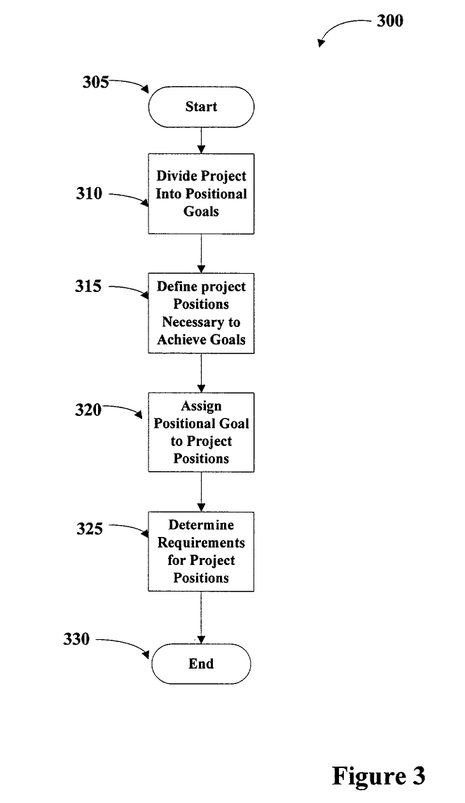

FIG. 3 illustrates a process 300 for determining project positions in a project management system. The process 300 begins at a START block 305. Proceeding to block 310, the process divides a project 105 into one or more positional goals. The positional goals are items that need to be performed by the project positions to successfully complete the project 105. The positional goals are differ from the project tasks 110 in that the positional goals define items in only one project position 115, where the project tasks 110 may be an item that multiple project positions 115 work on to complete. Of course, there may be similar positional goals among project positions 115.

Proceeding to block 315, the process 300 defines project positions 115 necessary to achieve the positional goals. The project manager should be able to easily determine the project positions 115 necessary based on the positional goals. For example, if a positional goal requires two man years of effort, and the project 105 is given six months to complete, the project manager can divide the positional goal into four separate positional goals, with each positional goal being assigned to a separate project position 115.

Proceeding to block 320, the process 300 assigns the positional goals to each project position 115. Each project position 115 may have one or more positional goal assigned, but generally each positional goal is only assigned to a single project position 115.

Proceeding to block 325, the process 300 determines the requirements for each project positions 115. Because the project positions 115 have been defined by positional goals, the project manager may easily determine the qualifications necessary for each project position 115. For example, if a positional goal requires software coding, the project position 115 may have a requirement of expertise in a particular software language. After determining the requirements for the project positions 115, the process 300 terminates in an END block 330.

Numerous variations and modifications of the invention will become readily apparent to those skilled in the art. Accordingly, the invention may be embodied in other specific forms without departing from its spirit or essential characteristics.

What is claimed is:

1. A method of project management comprising:
dividing a project into one or more positional goals;
defining one or more project positions based on the positional goals; and
assigning the one or more positional goals to the one or more project positions.

2. The method of claim 1, further comprising determining requirements for the one or more project positions.

3. The method of claim 1, further comprising defining project tasks.

4. The method of claim 3, further comprising correlating the one or more project positions to the project tasks.

5. The method of claim 4, further comprising generating a report showing correlation between the one or more project positions and the one or more project tasks.

6. An article comprising:
a storage medium having stored thereon instructions that when executed by a machine results in the following:
divide a project into one or more positional goals;
define one or more project positions based on the positional goals; and
assign the one or more positional goals to the one or more project positions.

7. The article of claim 6, wherein the requirements for the one or more project positions are determining.

8. The article of claim 6, wherein one or more project tasks are defined.

9. The article of claim 8, wherein the one or more project positions is correlated to the one or more project tasks.

10. The article of claim 8, wherein a report is generated showing correlation between the one or more project positions and the one or more project tasks.
